(19) United States
(12) Patent Application Publication
(10) Pub. No.: US 2024/0311770 A1
(43) Pub. Date: Sep. 19, 2024

(54) PROFESSIONAL MATCHING PORTAL HAVING INACTIVE CASE MANAGEMENT

(71) Applicants: Robert L. Heston, JR., Houston, TX (US); Barrett Canon, Houston, TX (US)

(72) Inventors: Robert L. Heston, JR., Houston, TX (US); Barrett Canon, Houston, TX (US)

(21) Appl. No.: 18/608,003

(22) Filed: Mar. 18, 2024

Related U.S. Application Data
(60) Provisional application No. 63/452,909, filed on Mar. 17, 2023.

(51) Int. Cl. G06Q 10/1053; G06Q 10/107

(52) U.S. Cl. CPC G06Q 10/1053; G06Q 10/107

(57) ABSTRACT

A portal allows a professional (e.g., an attorney) to be selected for hire based on a case that member users submit and allows a service provider to manage the cases that are inactive. Member users visiting the portal intake cases by entering criteria for selecting a professional. The portal includes a system platform programmed to automatically flag each of the cases that have timed out, returned no potential professional or an insufficient number of professionals matching the criteria, or been rejected by all the professionals matching the criteria, as inactive. A service provider visiting the portal can view the inactive cases that are automatically flagged. The portal allows the service provider to manually search for one or more professionals matching the criteria of an inactive case, manually refer one or more professionals in the inactive case, and unflag the inactive case.

### CROSS-REFERENCE TO RELATED APPLICATIONS

This application claims the benefit of priority to U.S. provisional application Ser. No. 63/452,909 filed on Mar. 17, 2023, which is incorporated herein by reference for any and all purposes.

### BACKGROUND

The disclosure relates generally to a portal allowing a professional (e.g., an attorney) to be selected for hire based on a case that is submitted by member users. On embodiment of the disclosure relates more particularly to a portal facilitating the management by a service provider of cases that are inactive, such as cases that are rejected by all the professionals matching the submitted cases, have timed out, or have returned no potential professional or an insufficient number of professionals matching the case.

Portals allowing users to select a professional for hire are known. For example, https://www.angi.com provides a portal such that users can select electricians, maid services, etc.

There is a need in the art for a portal allowing member users to select an attorney for hire that facilitates the management of cases that are inactive.

### BRIEF DESCRIPTION OF THE DRAWINGS

For a more detailed description of the embodiments of the present disclosure, reference will now be made to the accompanying drawings, wherein:

FIG. 1 is a flow diagram for implementing a portal that provides member users a single attorney at a time who has accepted a case submitted by the member user;

FIG. 2 is a flow diagram for implementing a portal that provides member users multiple attorneys at a time who have accepted a case submitted by the member user; and

FIG. 3 is an example view of the portal when it is visited by a member user.

### DETAILED DESCRIPTION

It is to be understood that the following disclosure describes several exemplary embodiments for implementing different features, structures, or functions of the invention. Exemplary embodiments of steps, components, arrangements, and configurations are described below to simplify the disclosure; however, these exemplary embodiments are provided merely as examples and are not intended to limit the scope of the invention.

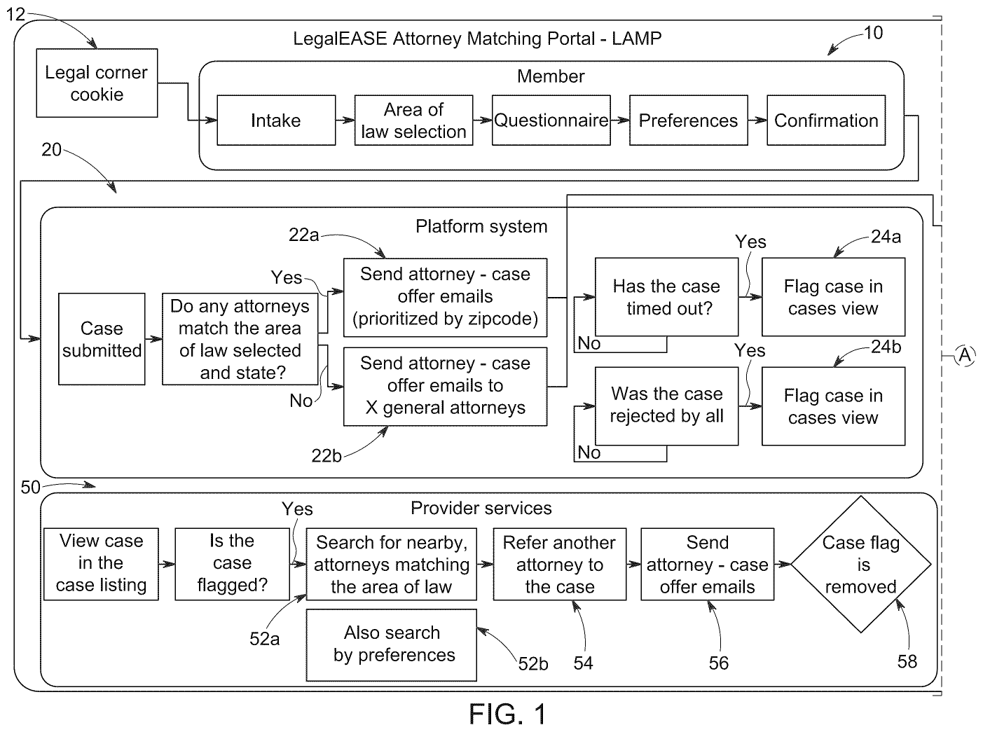

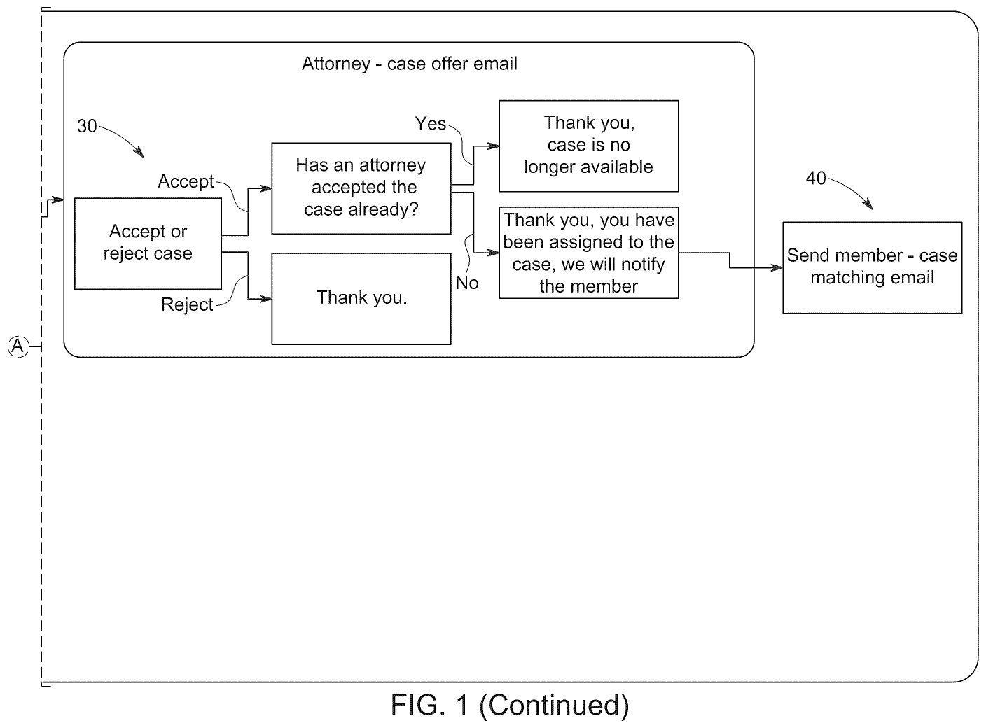

The disclosure describes in reference to FIGS. 1 and/or 2 a preferred embodiment of a portal allowing a professional (e.g., an attorney) to be selected for hire based on a case that is submitted by member users and allowing a service provider to manage the cases that are inactive.

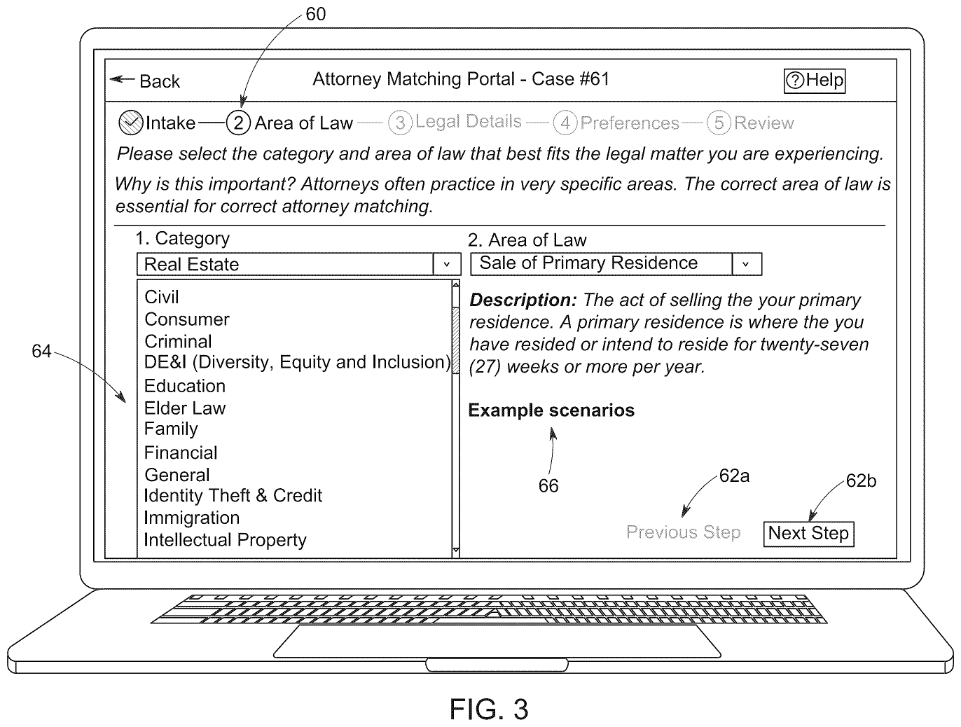

When the portal is visited by a member user at block 10, the portal allows the member user to submit a case. Preferably, in order to submit a case, the member user enter criteria, such as by selecting an area of law and/or state, filling out a questionnaire, providing preferences, and confirming the case. This portion of the portal can be implemented with Google or Nvidia Concierge. An example view of the portal is shown in FIG. 3. To facilitate the execution of block 10, the portal may store an HTTP Cookie 12 on the user's computer to verify a user and/or case identity.

The portal includes a platform system that is programmed to send, or otherwise capable of sending, case-offer emails to a plurality of professionals (e.g., attorneys) at steps 22a, 22b, and/or 22c of block 20. For example, if there are attorneys that match the criteria of area of law and state, these attorneys may be prioritized by zip code and be sent a case-offer email. Alternatively or additionally, general attorneys may be sent a case-offer email. At block 30, the platform system is further programmed to receive acceptance/rejection emails from the plurality of professionals to whom a case-offer email was sent.

In the embodiment shown in FIG. 1, the platform system is further programmed to send the member user a case-matching email listing a single professional that has accepted the case and then mark the case as assigned (or “matched”) at block 40. For example, the attorney having the higher priority may be listed in the case-matching email. This attorney may receive a case-assignment email. The other attorneys that have accepted the case may receive a case-unavailability email.

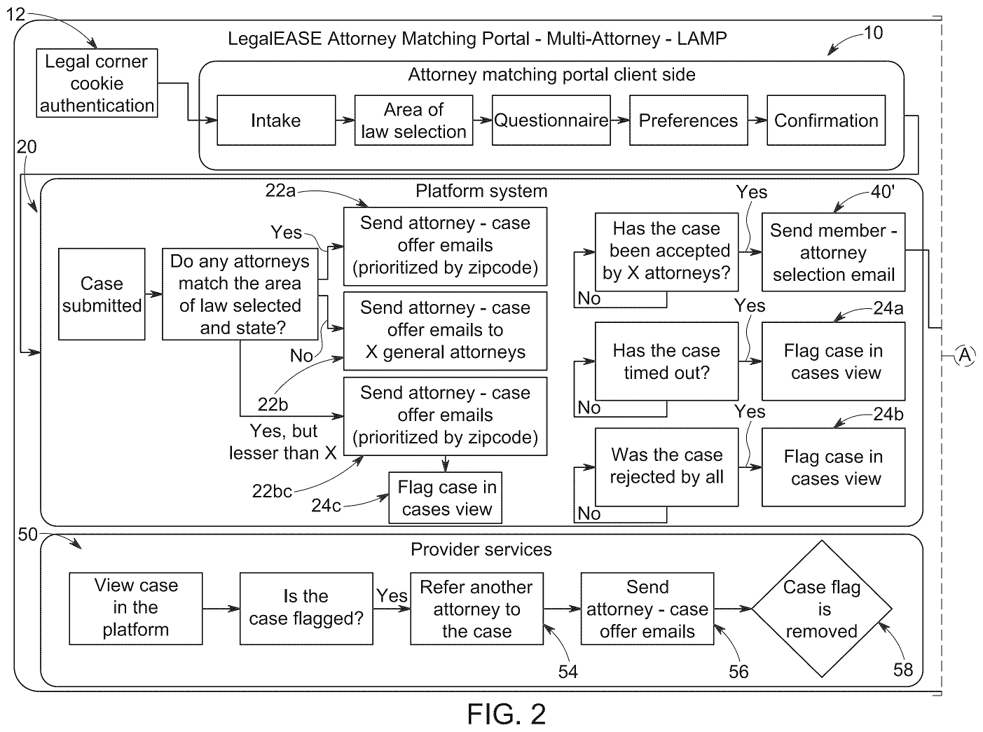

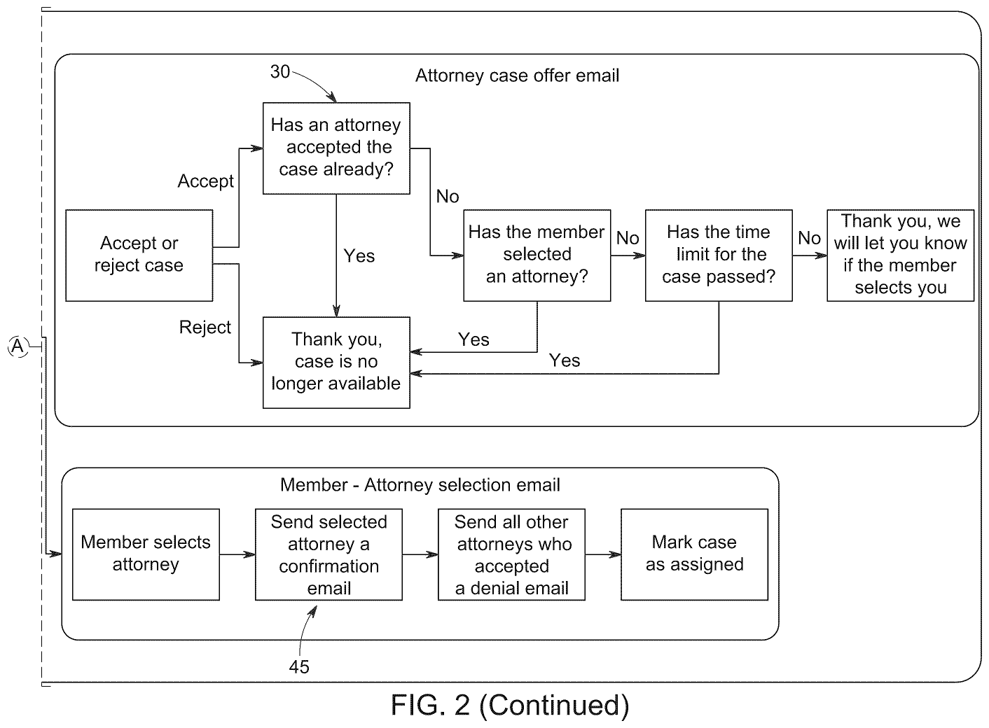

In the embodiment shown in FIG. 2, the platform system is further programmed to send the member user a selection email listing multiple professionals that have accepted the case at block 40′. The platform system is further programmed at block 45 to send a confirmation email to the professional selected by the member user, send a denial email to all the other professionals listed in the selection email, and then mark the case as assigned.

Unlike conventional system platforms, the system platform is further programmed to automatically flag cases that are inactive at steps 24a, 24b, and/or 24c of block 20. For example, a case may be flagged as inactive if it has timed out. Alternatively or additionally, a case may be flagged as inactive if all of the plurality of professionals that have received a case-offer email have rejected the case. Alternatively or additionally, a case may be flagged as inactive if it has returned no potential professional or an insufficient number of professionals matching the case.

When the portal is visited by a service provider at block 50, the portal allows the service provider to view at least the inactive or otherwise flagged cases. The portal allows the service provider to manually search for professionals that have the best chances to meet the criteria of any inactive case at steps 52a and/or 52b, and manually refer at step 54 one or more matching professionals for the platform system to send case-offer emails to them at step 56. Note that steps 52a and 52b are only illustrated in FIG. 1 for simplicity, but are similarly implemented in block 50 of FIG. 2. The portal also allows the service provider to unflag an inactive case at step 58 or more generally, an inactive or otherwise flagged case can be unflagged at step 58 after the case-offer emails are sent at step 56. Optionally, the portal allows the service provider to view all cases and/or all the assigned cases. Again, this portion of the portal can be implemented with Google or Nvidia Concierge.

FIG. 3 illustrates an example of the portal as viewed by a user. It illustrates at progress bar 60 a multi-step intake process of a case, that visualizes the status of the intake process. Buttons 62a and 62b allow navigation through the steps. A drop-down menu (e.g., 64) or questionnaire may be displayed at each step. Optionally, the drop-down menu or questionnaire may depend on the user choices made at one or more of the previous states. Also, hyperlinks (e.g., 66) may allow the display of additional information, such as concrete examples of the choices to be made.

1. A method of providing a portal allowing a professional to be selected based on criteria submitted by member users, comprising:
automatically flagging inactive cases; and
allowing a service provider visiting the portal to view the inactive cases that are automatically flagged,
wherein each of the inactive cases is one or more of:
a case having timed out,
a case having returned no potential professional or an insufficient number of professionals matching the criteria, or
a case rejected by all the professionals matching the criteria.

2. The method of claim 1, wherein the portal allows the service provider to manually search for one or more professionals matching the criteria and unflag an inactive case.

3. The method of claim 1, wherein the portal includes a system platform programmed to send emails to member users and to professionals.

4. The method of claim 1, wherein the portal allows the service provider to manually refer one or more professionals matching the criteria to a system platform programmed to send emails to professionals.

5. A method of providing a portal allowing service providers to select a professional based on criteria, comprising:
allowing member users visiting the portal to intake cases by entering criteria for selecting a professional;
automatically flagging inactive cases; and
allowing the service provider visiting the portal to view the inactive cases that are automatically flagged,
wherein each of the inactive cases is one or more of:
a case having timed out,
a case having returned no potential professional or an insufficient number of professionals matching the criteria, or
a case rejected by all the professionals matching the criteria.

6. The method of claim 5, wherein the portal allows the service provider to manually search for one or more professionals matching the criteria and unflag an inactive case.

7. The method of claim 5, wherein the portal includes a system platform programmed to send emails to member users and to professionals.

8. The method of claim 5, wherein the portal allows the service provider to manually refer one or more professionals matching the criteria to a system platform programmed to send emails to professionals.

9. A method of providing a portal allowing selection of a professional based on criteria, comprising:
allowing member users visiting the portal to intake cases by entering criteria for selecting a professional;
automatically flagging inactive cases;
allowing the service provider visiting the portal to view the inactive cases that are automatically flagged; and
allowing service providers to select a professional for the inactive cases based on the criteria,
wherein each of the inactive cases is one or more of:
a case having timed out,
a case having returned no potential professional or an insufficient number of professionals matching the criteria, or
a case rejected by all the professionals matching the criteria.

10. The method of claim 9, wherein the portal allows the service provider to manually search for one or more professionals matching the criteria and unflag an inactive case.

11. The method of claim 9, wherein the portal includes a system platform programmed to send emails to member users and to professionals.

12. The method of claim 9, wherein the portal allows the service provider to manually refer one or more professionals matching the criteria to a system platform programmed to send emails to professionals.

13. The method of claim 1 wherein the professional is an attorney.

14. The method of claim 5 wherein the professional is an attorney.

15. The method of claim 9 wherein the professional is an attorney.
